(19) United States
(12) Patent Application Publication
(10) Pub. No.: US 2009/0014219 A1
(43) Pub. Date: Jan. 15, 2009

(54) Cart With Lift And Drive Assist

(75) Inventors: Eric D. Springston, York, SC (US); John R. Pratt, Charlotte, NC (US); Dale A. Williams, Fort Mill, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: MULTI-SHIFTER INC., Charlotte, NC (US)

(21) Appl. No.: 11/814,231

(22) PCT Filed: Jan. 19, 2006
(86) PCT No.: PCT/US2006/001825

§ 371 Date: Jun. 5, 2008

Related U.S. Application Data
(60) Provisional application No. 60/644,900, filed on Jan. 19, 2005.

(51) Int. Cl. B62D 51/04; B62B 5/00; B62D 51/00; B62B 3/00

(52) U.S. Cl. 180/19.1

(57) ABSTRACT

There is provided a cart for lifting and moving materials. The cart includes a lift mechanism for raising and lowering a support surface to lift the materials during transport. The cart also includes a motorized drive wheel assembly which provides a drive force in a forward or backward direction to assist the operator in moving the materials. The motorized drive wheel assembly has a variable vertical position relative to the cart wheels to enable the drive wheels to provide a drive force over contoured surfaces, such as near the base or top of a ramp. The motorized drive wheel assembly also includes a weight to maintain a minimum normal force for traction and includes a differential to allow the drive wheels to rotate at differing speeds to facilitate convenient steering of the cart. The cart is powered by one or more rechargeable batteries.

### BACKGROUND OF THE INVENTION

1. Field of the Invention

The present invention is related to carts for material handling, and more particularly, to carts that assist in lifting and moving materials.

2. Description of Related Art

Various types of carts are often used to assist in the handling of materials. Such carts may simply provide one or more surfaces for supporting materials, such as a standard push/pull cart, while other carts may be configured to engage a corresponding device that is supporting the materials, such as a pallet jack for use with materials on pallets. Such devices often include mechanical and/or electromechanical devices for lifting these corresponding devices and may include electromechanical devices to assist in the transporting of the material. Additionally, a variety of cart configurations and features are available for handling materials with or without separate supports, containers, racks, or the like.

These carts may be used to transport materials over inclined surfaces. One difficulty created by carts ascending or descending inclined surfaces is when the cart passes over the break point defined by the intersection of the top of the inclined surface and a generally level surface or passes over the depression defined by the intersection of the bottom of the inclined surface and another generally level surface. Such a situation is common when moving a cart along a ramp from the ground to a vehicle surface, such as a truck bed. Moving a cart, whether manually driven or electromechanically driven, over such a break point or depression may be difficult for an operator, particularly if the cart defines a large longitudinal length relative to the angle of the inclined surface. If the cart is driven by an electromechanical device or the like, such drive device may lose contact with the ground or inclined surface as the drive device is positioned approximately above the depression. In addition, as the cart passes over the break point, the break point may contact the underside of the cart or other portion of the cart such that the operator must either allow the uppermost wheels to temporarily suspend above the level surface or temporarily lift the lowermost wheels above the inclined surface. Such loss of contact between the wheels of the car and the inclined or level surface may not only be difficult for the operator to achieve, but may also be unsafe for the operator or the materials being transported. Therefore, a need exists for a cart that provides convenient lifting and moving of materials over a variety of surfaces, particularly inclined surfaces.

### BRIEF SUMMARY OF THE INVENTION

Embodiments of the present invention address the need for a cart that conveniently lifts and moves materials over level and inclined surfaces. The cart of one embodiment of the present invention includes a cart frame and a support surface joined to the cart frame such that the support surface is capable of selective vertical movement relative to an upper portion of the cart frame. The support surface is selectively raised and lowered by a lift mechanism connected to the cart frame and to the support surface. The cart further includes at least one wheel attached to the cart frame and a drive wheel assembly attached to the cart frame and capable of selectively providing drive motion to the cart in at least one direction. The drive wheel assembly is also capable of moving in at least a vertical direction relative to the cart frame while providing drive motion to the cart. The cart also includes a control assembly which an operator may use to control the lift mechanism to selectively raise and lower the support surface. The control assembly may also be used to control the drive wheel assembly to selectively provide drive motion to the cart.

An alternative embodiment of the present invention includes a cart and rack assembly, in which the rack selectively includes the materials to be transported. The rack includes at least one foot extending from a bottom surface of the rack such that the rack provides enough clearance for a cart of the present invention to be positioned below the bottom surface of the rack. Further embodiments of the present invention include carts and cart and rack assemblies having additional components to assist in the raising and lowering of the materials, in the transporting of the materials over level and inclined surfaces, and in the steering of the cart.

The present invention also provides methods for transporting materials. To transport materials according to one embodiment of the present invention, the cart is positioned such that at least a portion of the cart frame is situated below the material to be transported. The support surface of the cart is raised to lift the materials until the materials are substantially supported by the support surface of the cart. The cart is then moved by controlling a drive wheel assembly that is attached to the cart frame. The drive wheel assembly is capable of moving in at least a vertical direction relative to the cart frame while the drive wheel assembly provides drive motion to the cart, thus the present invention provides drive motion when the cart passes over the break point and depression defined by an inclined surface. Once the cart has transported the material to a desired location, the support surface is lowered until the materials are substantially removed from the support surface. Therefore, the present invention provides convenient raising and lowering of materials requiring transport and provides convenient movement of materials over level and inclined surfaces.

### BRIEF DESCRIPTION OF THE SEVERAL VIEWS OF THE DRAWINGS

Reference will now be made to the accompanying drawings, which are not necessarily drawn to scale, and wherein:

FIG. 1 is a perspective view of a cart of one embodiment of the present invention, illustrating the support surface in the upward position;

FIG. 2 is a perspective view of the cart of FIG. 1 with the support surface and wiring assembly cover removed for illustrative purposes;

FIG. 3 is an enlarged, partially exploded, perspective view of the frame assembly of the cart of FIG. 1, illustrating the lift mechanism for raising and lowering the support surface;

FIG. 4 is an enlarged, partially exploded, perspective view of the motorized drive wheel assembly of the cart of FIG. 1, illustrating the motor, the differential, and the cantilevered weight;

FIG. 5A-5D are enlarged, partially exploded, perspective views of the control assembly of the cart of FIG. 1, illustrating the control handles, the control switch, the emergency stop, the key switch, and the battery indicator;

FIG. 6A-6B are enlarged, partially exploded, perspective views of the wiring assembly of the cart of FIG. 1;

FIG. 7 is a circuit diagram for the cart of FIG. 1;

FIG. 8A-8K are various views of the cart of FIG. 1, illustrating the lift mechanism, the battery compartment, and motorized drive wheel assembly;

FIG. 9A-9L are various views of the control assembly of the cart of FIG. 1;

FIG. 10A-10F are various views of the lift mechanism of the cart of FIG. 1;

FIG. 11A-11C are side elevational environmental views of the cart of FIG. 1, illustrating the cart immediately before positioning under the rack, partially positioned under the rack, and fully positioned under the rack, respectively; and

FIG. 12A-12B are side elevational environmental views of the cart of FIG. 1, illustrating the cart with a loaded rack, such that the motorized drive wheel is positioned above the break point and the depression, respectively.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

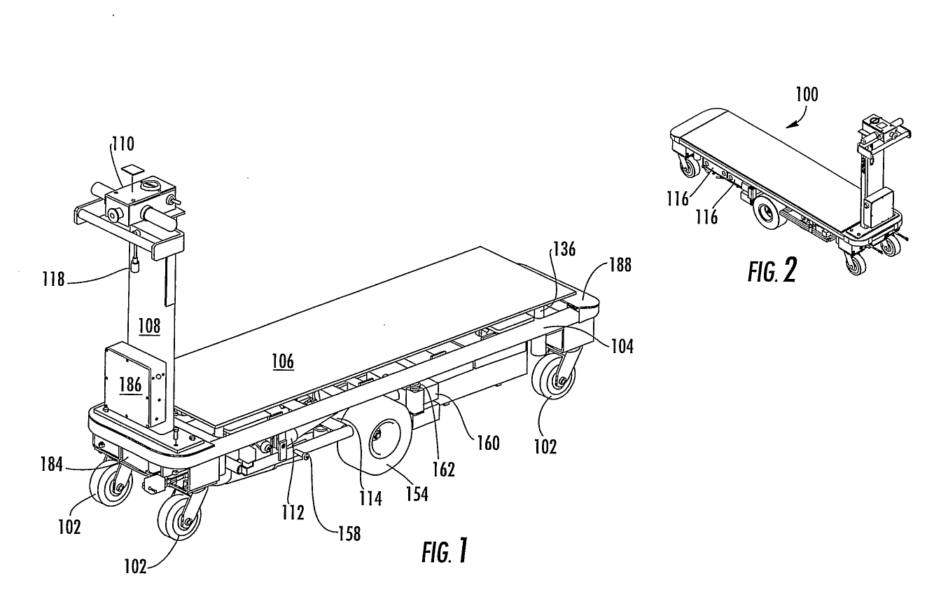

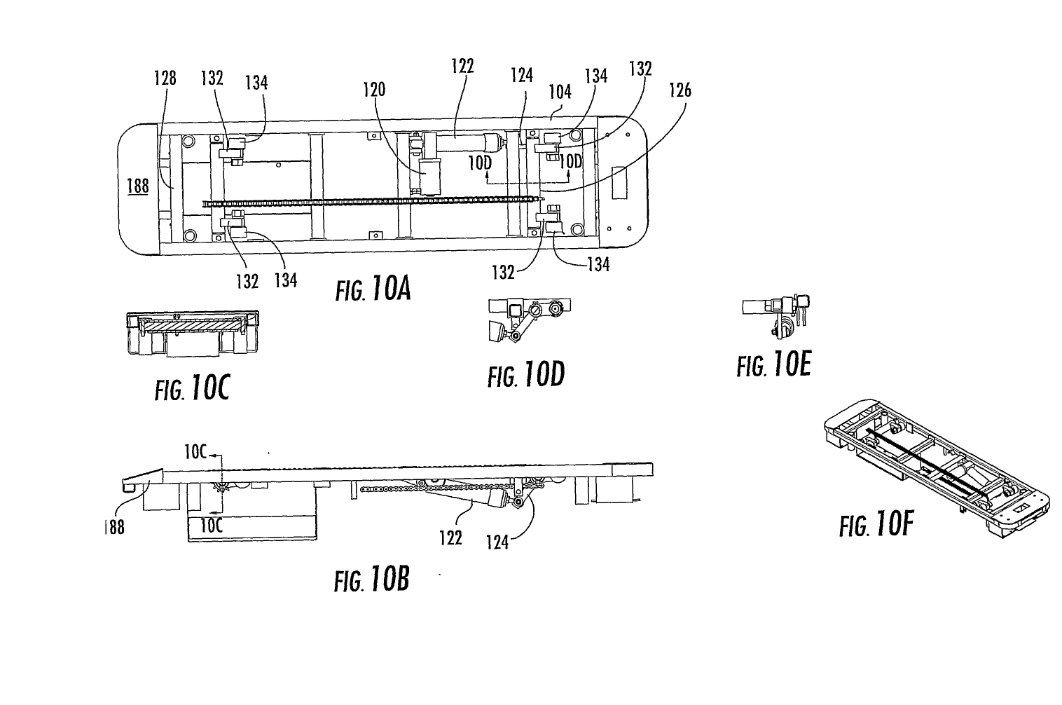

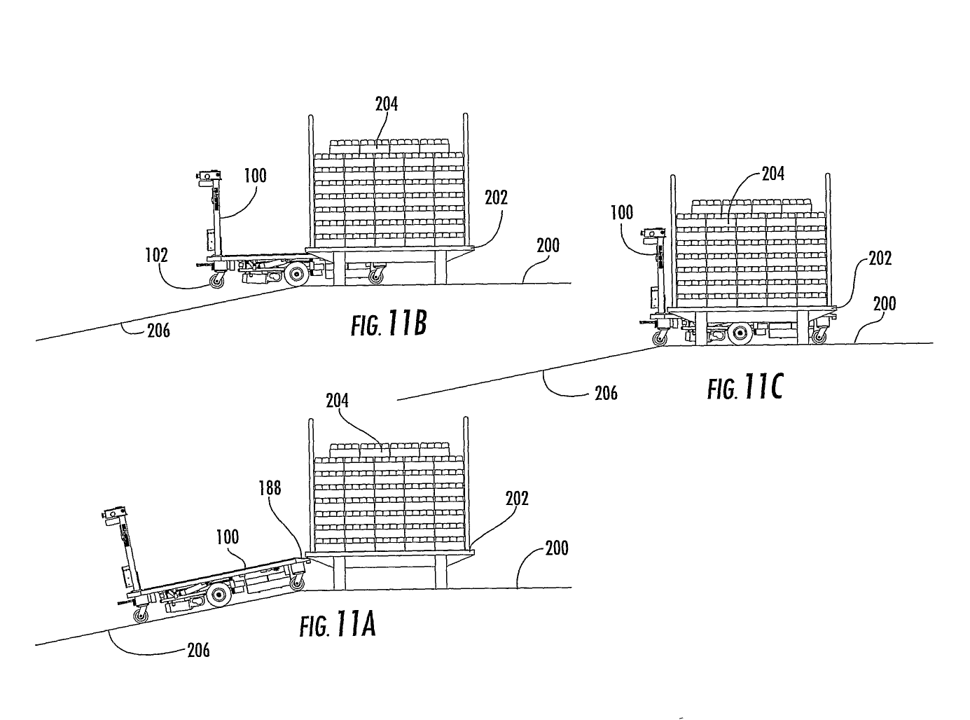

With reference to FIGS. 1-12B, a cart in accordance with one embodiment of the present invention is illustrated. The cart 100 of FIGS. 1-12B is specifically configured for use with beverage racks used in delivery vehicles. Further embodiments of the present invention include carts having alternative configurations for other specific applications, such as transporting components in a manufacturing environment or the like, or for other general applications, such as transporting retail fixtures, furniture, retail products, storage containers, or the like. Accordingly, the motorized drive wheel assembly, the lift mechanism, the control assembly, and the other portions of the cart of the present invention may define alternative relative shapes, locations, and configurations corresponding to the intended use of the cart.

Referring now to FIGS. 1 and 2, the cart 100 comprises two or more wheels 102, such as four wheels, located at the corners of the cart. The wheels 102 may be any type of device that facilitates movement of the cart, such as casters, rollers, or the like, and are able to pivot to facilitate steering of the cart 100. The wheels 102 are attached to the cart frame 104 which includes a support surface 106 that can be configured to engage the materials to be transported. The cart frame 104 defines opposing longitudinal sides and opposing lateral sides of any relative lengths, and the cart frame includes an upright 108 onto which a control assembly 110 is mounted. The control assembly 110 is advantageously mounted at such a height that is ergonomically convenient for operators of the cart 100. The control assembly 110 includes controls for activating a lift mechanism 112, which raises and lowers the support surface 106 of the cart 100, and for operating a motorized drive wheel assembly 114, which provides forward or reverse motion to the cart during operation. The cart 100 is powered by one or more batteries 116, which are illustrated in FIG. 2, that can be recharged as needed by plugging in the retractable plug 118 provided in the upright 108. As described more fully below, an operator of the cart 100 is therefore able to conveniently lift materials requiring transport and to move the materials by simply adjusting the controls on the control assembly 110.

To lift and support the materials requiring transport, a portion of the cart 100, such as the entire support surface 106, is positioned under the material. When the operator activates a lift switch on the control assembly 110, the lift mechanism 112 raises the support surface 106 until the operator deactivates the lift switch or the support surface is raised to a maximum height. The lift mechanism 112 illustrated in FIG. 3 includes a first motor 120, which is in electrical communication with the lift switch of the control assembly 110, that drives an actuator 122 using a ball screw or the like. The actuator 122 pushes a linkage 124 that rotates a first shaft 126. The first shaft 126 is in mechanical communication with a second shaft 128 that is located proximate an opposite longitudinal side of the cart frame 104. Similarly, the shafts are proximate opposite lateral sides in further embodiments of the present invention. The first shaft 126 and second shaft 128 are in mechanical communication, such that they rotate a substantially equivalent amount, by a first chain 130 that is wrapped around sprockets or gears on the respective shafts, as shown in FIG. 3 (a portion of the chain is not shown for illustrative purposes). Further embodiments of the cart may include alternative connections, such as belts, individual motors, or the like, to rotate the shafts substantially equivalent amounts.

The first and second shafts 126 and 128 each include pivot brackets 132 with cam followers 134 that pivot upward and exert an upward force on the bottom side of the support surface 106 as the shafts are rotated by the outward actuation of the actuator 122. Conversely, as the actuator strokes inwardly, the cam followers 134 pivot downward to allow the support surface 106 to lower. Preferably, the cam followers 134 include rollers or other components that create minimal friction and wear on the support surface. Additionally, the first motor 120 enables the lift mechanism 112 to lift 1,000 pounds or more as required. Further embodiments of the cart include lift mechanisms having alternative components or configurations.

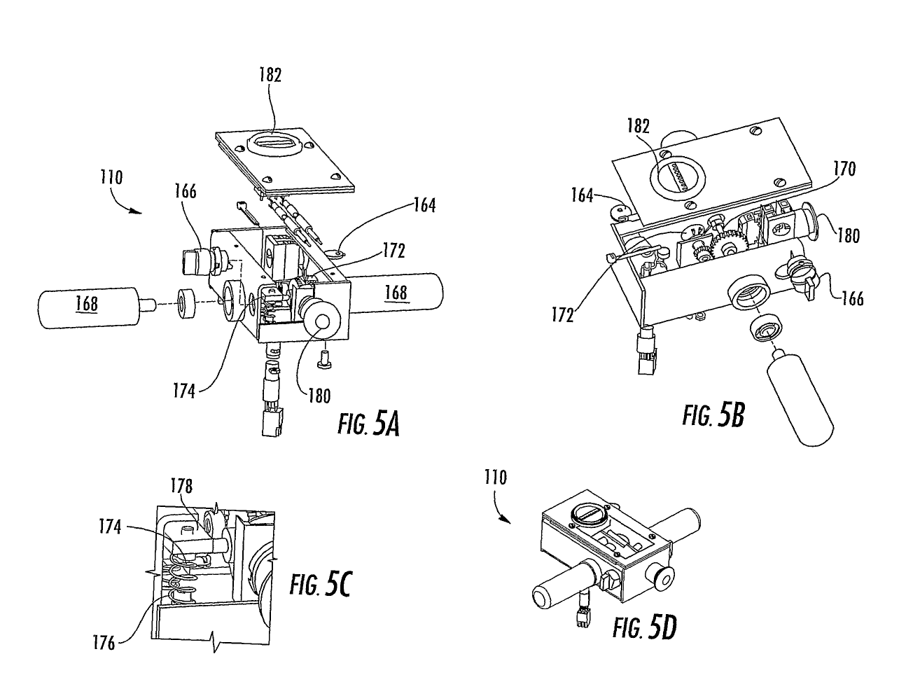

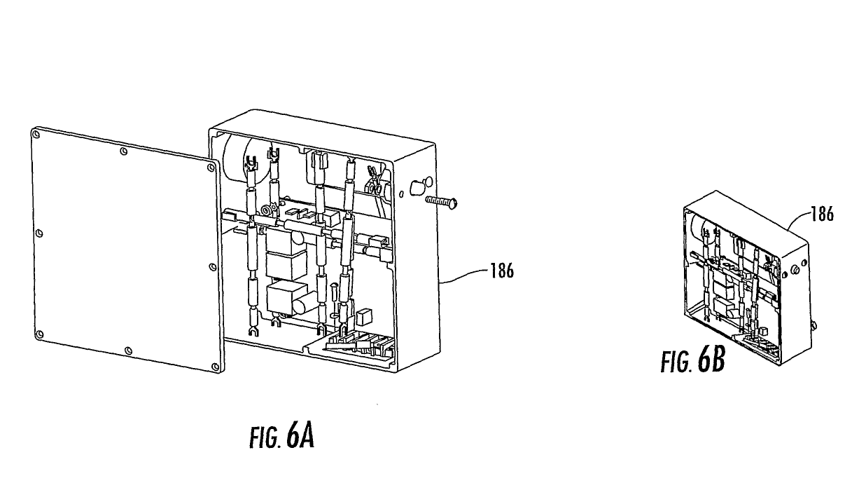

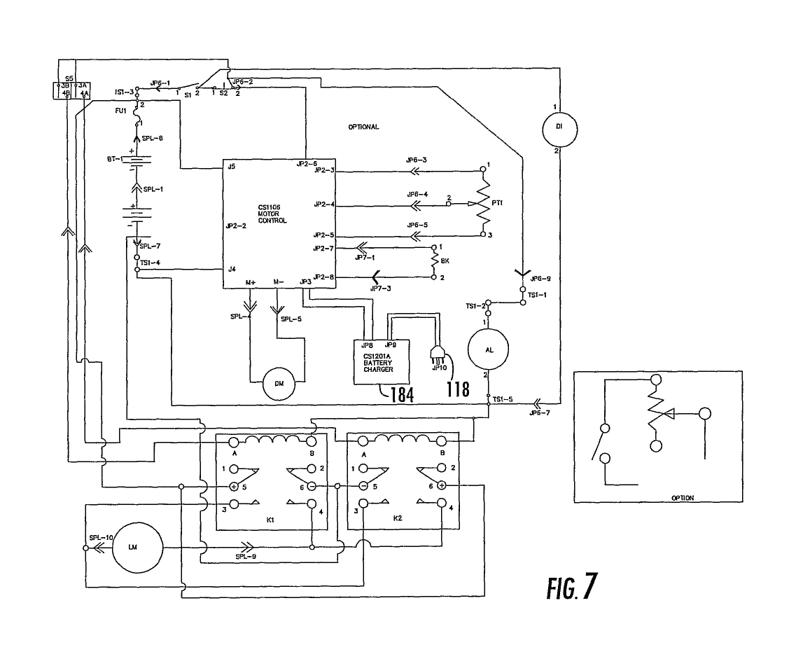

As shown in FIGS. 1 and 8J, the support surface 106 includes pins 136 extending substantially perpendicular downwardly near the four corners and on the downward side of the support surface. The cart frame 104 includes bushings 138, as shown in FIG. 8J, that have an inner diameter that is slightly larger than the outer diameter of the pins 136 and that comprise a relatively long-wearing yet resilient bushing material, such as nylon or the like, such that the support surface is lifted substantially perpendicular to the plane of the support surface. The support surface 106 is removable from the cart frame 104. Further embodiments of the present invention include support surfaces and lift mechanisms having alternative devices for providing for the raising and lowering of the support surface and/or that allow for non-perpendicular motion of the support surface. To allow for safe and effective lifting and retention of the material to be transported, the support surface 106 of the cart 100 may include an appropriate type of surface texture and/or is shaped to correspond to the material to be transported. The support surface 106 of the illustrated embodiment comprises a relative thin sheet of metal having wear plates welded thereto to receive the cam followers 134. This feature is especially useful for beverage racks of the type described below, because the support surface 106 does not include any stiffeners on the underside of the support surface that might compromise the relatively low height required to clear the underside of the beverage racks.

The motorized drive wheel assembly 114, as shown in FIG. 4, includes a second motor 140 that is also capable of bidirectional rotation to provide forward and reverse motion to the cart 100. The second motor 140 is in electrical communication with control handles of the control assembly 110. The second motor 140 also includes an electromechanical brake 141 attached to an end of the second motor opposite a first sprocket 142. The electromechanical brake 141 locks the motor in place when the cart 100 is on but the operator is not driving the cart forward or backward. The electromechanical brake 141 also locks the motor in place when a stop switch on the control assembly 110 is pressed, as described more fully below. To drive the cart during normal operation, the second motor 140 rotates the first sprocket 142 using a right angle gearbox 143. Rotation of the first sprocket 142 rotates a chain 144 that is connected to a second sprocket 146 that drives a differential 148. The differential 148 is connected by shafts 150 and 152 to the drive wheels 154 and 156, respectively. By providing a differential, as opposed to a transaxle, the motorized drive wheel assembly 114 of the cart 100 of the present invention enables the drive wheels to rotate at different relative speeds, thus providing improved maneuverability of the cart particularly during sharp turns. In particular, the drive wheels 154 and 156 are positioned at or near the center of the longitudinal length of the cart 100 so that the cart can pivot fully about its central axis, thus decreasing the amount of room necessary to turn the cart. The drive wheels 154 and 156 include foam-filled or inflated rubber tires to provide an amount of shock absorption.

The motorized drive wheel assembly 114 of the cart 100 is attached to the cart frame 104 by pins 158, as shown in FIGS. 1 and 8A. The pins 158 allow the motorized drive wheel assembly 114 to pivot about the pins such that the drive wheels 154 and 156 are free to move upwards and downwards relative to the cart wheels 102. The motorized drive wheel assembly 114 also includes at least one weight 160 that is preferably cantilevered beyond the drive wheels 154 and 156, relative to the pins 158, so that the drive wheels will maintain contact with the ground with enough normal force to provide a drive force to the cart 100 if the ground or other surface below the drive wheels is relatively lower than the ground or surface below the cart wheels 102. The motorized drive wheel assembly 114 further includes springs 162 (as shown on FIG. 8A) connecting the cantilevered end of the assembly to the cart frame 104 to dampen the vertical motion of the drive wheels 154 and 156 relative to the cart wheels 102. Further embodiments of the cart of the present invention include alternative components and configurations for driving the drive wheels and for allowing vertical motion of the drive wheels relative to the cart wheels.

The cart 100 also includes a transmission switch 163 for selectively disengaging the gearbox 143. The transmission switch 163 extends upwardly from the gearbox 143, as shown in FIG. 4. By rotating the transmission switch 163 a predetermined amount, such as 90 degrees, the operator is able to disengage the gearbox 143, thus allowing the cart to be pushed freely without the second motor 140 affecting the rotation of the drive wheels 154 and 156. Disengaging the gearbox 143 is particularly useful when the batteries 116 have died or have insufficient power to drive the cart 100 or when the operator intends to preserve the battery power, to list two non-limiting reasons to disengage the gearbox. Further embodiments of the cart include alternative devices for allowing the drive wheels to rotate free of the second motor.

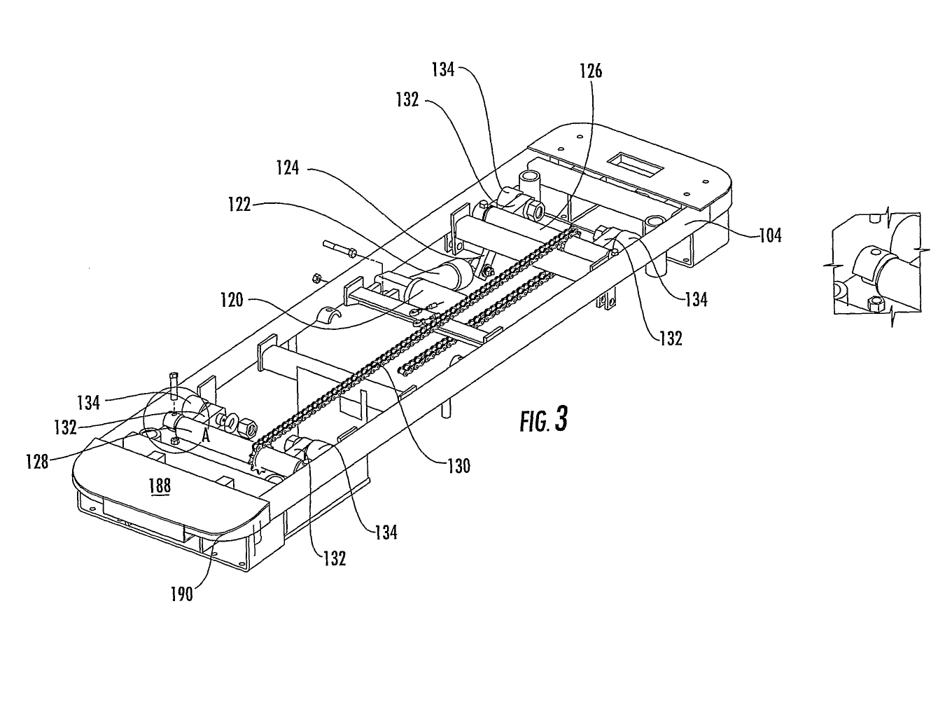

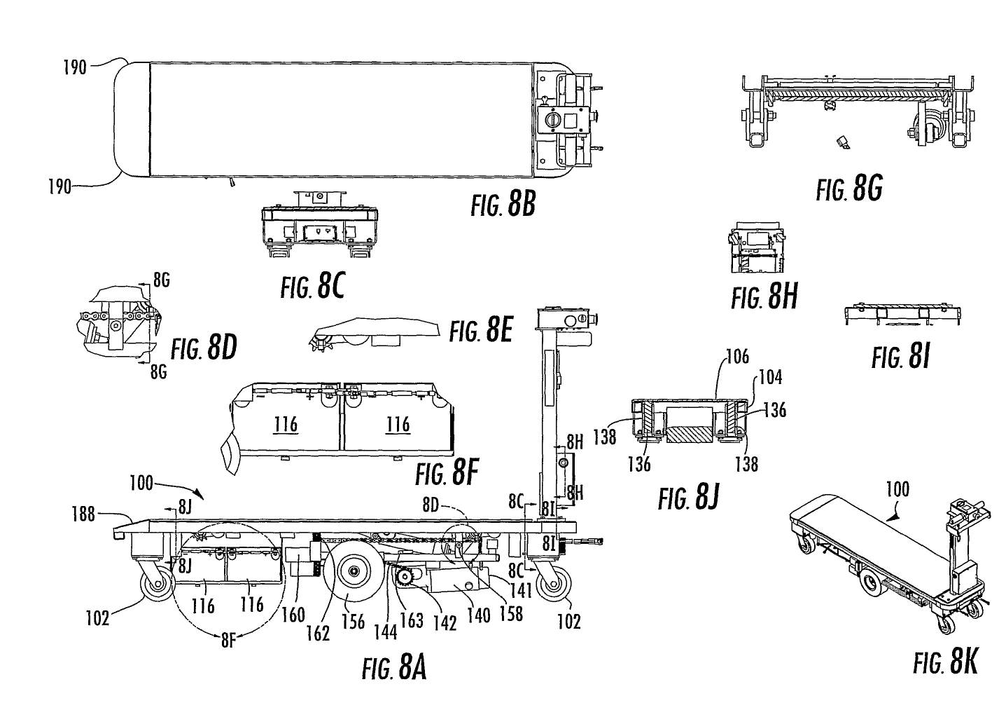

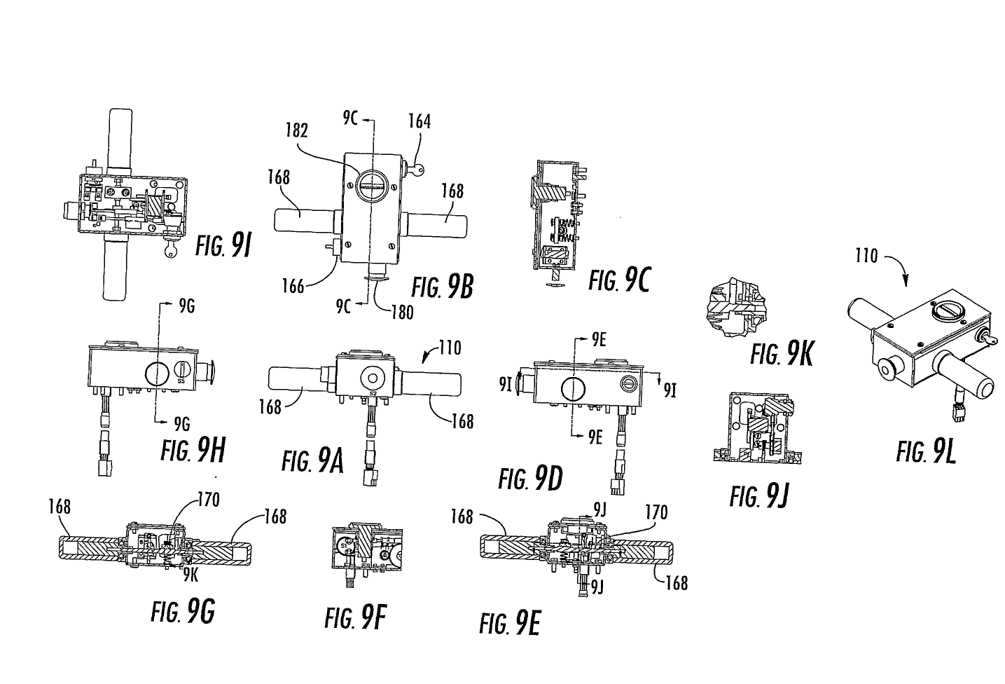

The control assembly 110, as shown in FIGS. 5A-5D and 9A-9L, includes controls for powering the cart 100 on and off, for raising and lowering the support surface 106, for driving the cart forward and backward, and for stopping the cart in emergencies, and provides an indicator of remaining battery power. Specifically, a key switch 164 is provided on a side of the control assembly 110 and comprises a standard key switch as known in the art. The key switch 164 enables the cart 100 to be powered on and off only by operators possessing the appropriate key. Once the cart 100 is powered on, an operator may turn a lift switch 166 between three discrete positions to move the support surface 106 up, to move the support surface down, or to keep the support surface in a fixed position relative to the cart frame 104. The lift switch 166 is also provided on a side of the control assembly 110 and comprises a standard switch device as known in the art. Further embodiments of the cart include alternative key switches and/or lift switches for powering the cart and raising/lowering the support surface, such as a lift switch specifically adapted for additional lifting capabilities to list one non-limiting example.

The control assembly 110 also includes control handles 168 that extend outward from opposing sides of the control assembly and that are rotatable relative to the control assembly. The control assembly 110 and control handles 168 provide enough structural strength so that an operator is able to use the control handles to steer the cart 100 during operation and to push/pull the cart when the cart is not driven by the drive wheels 154 and 156. During normal operation of the cart 100, the operator rotates the control handles 168, relative to the control assembly, to drive the drive wheels 154 and 156. The cart is driven forward by rotating the control handles 168 such that the top of the control handles is moved forward, and if the top of the control handles is moved rearward/backward, the cart is driven backward. The control handles 168 are rotatably fixed to one another by a handle shaft 170 that connects the two handles through the control assembly 110. An operator is therefore able to rotate the control handles 168 using only one of the two handles.

The handle shaft 170 is in mechanical communication, through one or more gears, to a potentiometer 172 that measures the direction and amount of rotation of the control handles 168 and sends a signal, either directly or through processing circuitry, to the second motor 140 to drive the drive wheels 154 and 156 the direction and speed intended by the operator. The speed of the drive wheels 154 and 156 is dependent upon the amount the control handles are rotated. For example, if the operator rotates the control handles 168 forward a first angular amount the drive wheels will rotate forward at a first speed, and if the operator rotates the control handles forward a second angular amount the drive wheels will rotate forward at a second speed such that a linear relationship exists between the amount of handle rotation and the speed of the drive wheels for both forward and backward rotation. The control handles 168 include a mechanical maximum position that coincides with the maximum drive wheel speed in each direction. The relationship of the handle rotation to drive wheel speed is substantially equivalent for both forward and backward rotation of the control handles 168.

The control handles 168 define a center position wherein the drive wheels are not driven in either direction. The control handles 168 include a spring mechanism 174 that predisposes the control handles to the center position unless an operator exerts a constant force to keep the control handles 168 rotated away from the center position. Similar rotatable handles incorporate torsion springs, as known in the art, to maintain the center position of the handles. Such use of torsion springs may be undesirable because of their propensity to break after repeated use. To address this deficiency, the cart 100 of the present invention includes compression springs 176 attached to a plate 178 that is connected to the handle shaft 170, such that rotation of the handle shaft causes the springs to contract and expand, thus exerting forces onto the plate and shaft in a rotational direction opposite the direction the operator has rotated the handle shaft. Thus, when an operator releases the control handles 168, the forces provided by the springs will cause the handle shaft 170 to return to the central position. Therefore, the springs and plate provide a much longer useful life for the control handles 168 compared to torsion springs or the like. Further embodiments of the present invention include alternative devices for returning the control handles back to a center position.

The control assembly 110 also includes a stop switch 180 that is located on the side of the control assembly facing the operator. The stop switch 180 allows the cart 100 to immediately stop the drive wheels 154 and 156 using the electromechanical brake 141 when the stop switch is pushed to prevent injury to the operator and/or damage to the cart or materials. Situations may arise where the operator is pinned between the cart 100 and another surface, such as a wall, and because the stop switch 180 is the forward-most surface of the cart, the stop switch will preferably be the first surface contacted by the body of the operator, thus stopping the cart from advancing forward further with the intent of preventing or minimizing injury or damage. Further embodiments of the cart of the present invention include alternative and/or additional stop switches to provide for safe operation of the cart. Additional safety components, such as an audio device for indicating motion, are also included in further embodiments of the present invention.

The control assembly 110 includes a battery power indicator 182 to inform an operator as to how much power is remaining so that an operator will know when to charge the cart or if the cart is sufficiently charged. The battery power indicator 182 is mounted on the top of the control assembly 110 such that it is easily viewed by an operator during use; however, further embodiments of the present invention include the indicator at alternative locations. The battery power indicator 182 is an array of LEDs that represent the amount of power remaining in the batteries or an LCD screen that includes a gauge or numeric readout that represents the battery power. Further embodiments of the cart include alternative and/or additional devices for representing the remaining power of the battery. The battery power indicator 182 includes a specific signal, either visual or audio, for indicating that the battery power is below a threshold and charging is recommended.

The cart 100 of the illustrated embodiments is recharged by plugging the retractable plug 118 into a standard 120 volt, 60 Hz power outlet or the like. A charger 184, as shown in FIG. 1, is included on the cart 100 to charge the batteries 116. Further embodiments of the present invention provide alternative devices and/or techniques for charging the batteries, such as removing the batteries from the cart or plugging a charger wire directly to the batteries to list two non-limiting examples. Referring again to FIG. 2, the cart 100 includes two 12 volt batteries 116 mounted to the cart frame 104 under the support surface 106. The batteries are electrically connected to the charger 184, the control assembly 110, and/or the first and second motors 120 and 140 to power the cart 100. The batteries 116 are retained in a shelf using simple fasteners and/or cables, as shown in FIGS. 8A and 8F, for convenient removal, installation, and/or replacement as necessary. Carts of further embodiments of the present invention include power supplies that are more or less integrated into the cart frame, that include alternative numbers of batteries, that include batteries that provide alternative amounts of power, or the like.

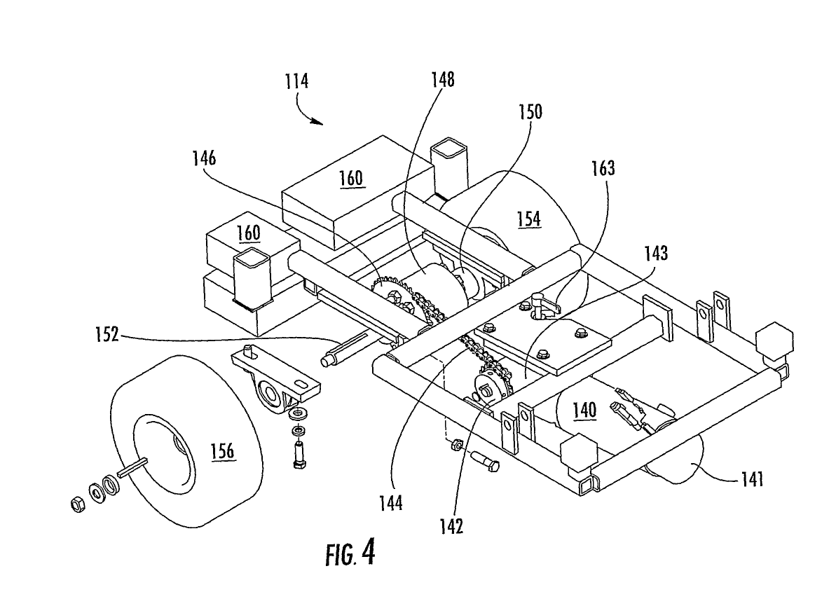

The cart 100 also includes a wiring assembly 186 to which all the electrical components are connected. The wiring assembly 186, as shown in FIGS. 2, 6A, and 6B houses the wiring from the various components, such as the switches of the control assembly 110, the first and second motors 120 and 140, the batteries 116, and the like, and houses various circuit boards, breakers, relays, and like, which are necessary to control all of the electrical components of the cart 100. A circuit diagram for the illustrated embodiment is provided in FIG. 7. The circuit advantageously disables operation of the cart when the retractable plug 118 is plugged into outlet to prevent dangerous operation. The wiring assembly 186 is mounted at the base of the support 108 and includes a cover; however, further embodiments of the present invention may provide the wiring assembly at any location on or within the cart.

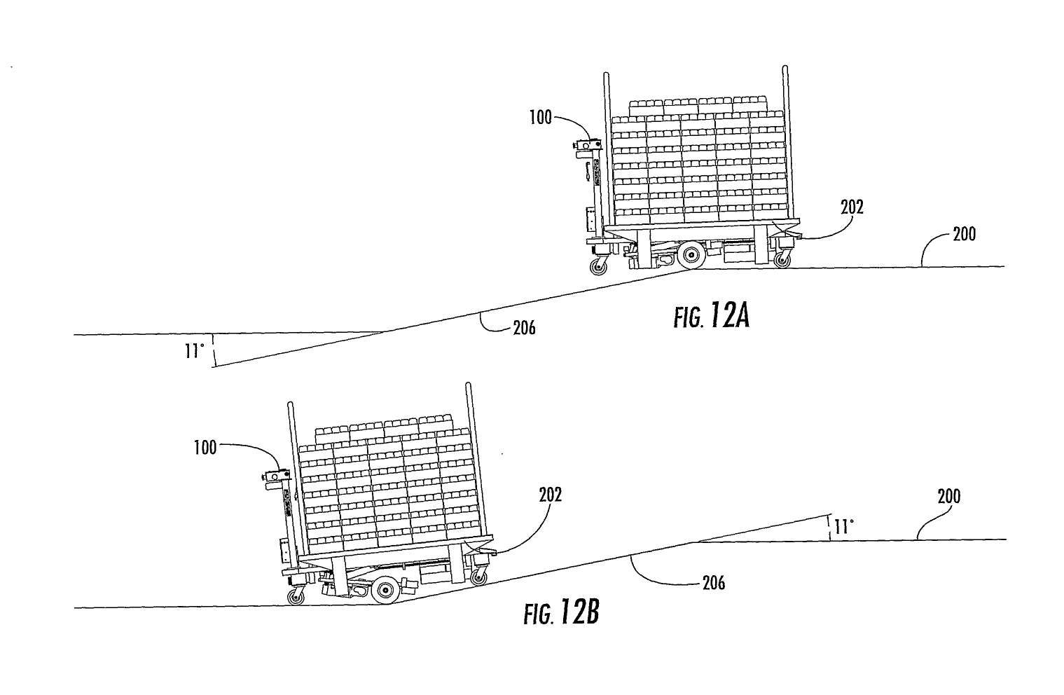

Use of the cart 100 to load and unload beverage racks from a delivery truck 200 is illustrated in FIGS. 11A-12B. Delivery trucks 200 often include racks 202 that contain the materials 204, such as cases of beverages, that require transport from the truck, down a ramp 206, and to a customer. The delivery trucks 200 include multiple racks 202 at one time, such as trucks that can hold three racks in a width direction and three or more racks in a length direction. The cart 100 is dimensioned such that it may be positioned below one rack 202 in a loaded truck 200 such that it is transported in the truck with the racks. The racks 202 of FIGS. 11A-12B can include feet that define a height of approximately 11 inches and an internal width of 16.5 inches. Such racks might also have wheels (non illustrated) that define the same clearance dimensions. Therefore, the cart 100 has a support surface height of less than 11 inches from the bottom of the wheels when the support surface is lowered and a support surface height greater than 11 inches when the support surface is raised. Additionally, the cart 100 must define a lateral width of less than 16.5 inches for the cart to be positioned below the rack 202. Further embodiments of the cart define alternative dimensions based upon the specific application for which they are intended.

To position the cart 100 below the rack 202 in the truck 200, the operator turns the cart on and drives it forward up the ramp 206 while aligning the cart to the rack. Once the cart 100 is properly aligned, the nose 188 of the cart at the forward edge of the cart passes beneath the rear edge of the rack 202. The nose 188 of the cart 100, as shown in FIGS. 3, 8A, and 8B, includes radiused corners 190 to provide for more convenient alignment of the cart and to minimize damage to the cart and/or rack.

The nose 188 of the cart 100 also defines an angled top surface to allow the forward edge of the cart to pass beneath the rack, particularly when the cart is angled relative to the rack as the cart ascends the ramp 206. FIG. 11A illustrates how the angled top surface of the nose 188 allows the cart 100 to roll under the rack 202 without hitting the rack and without requiring the operator to lift the rear of the cart such that only the front cart wheels 102 are contacting the ramp and/or truck bed. The angled top surface of the nose 188 allows the drive wheels 154 and 156 to stay on the ramp and truck bed during the entire positioning of the cart 100. The rear cart wheels 102 of the cart 100 will rise above the ramp 206, as shown in FIG. 11B, as the cart is positioned; however, the majority of the weight of the cart will be supported by the drive wheels 154 and 156, thus the operator is not required to lift any significant weight. After the support surface 106 of the cart 100 is substantially parallel to the bed of the truck 200, the cart 100 may be simply positioned the remaining amount, as shown in FIG. 11C.

To remove the rack 202 from the truck 200, the operator turns the lift switch 166 to cause the first motor 120 to rotate the shafts 126 and 128 to lift the support surface 106 an amount to sufficiently lift the rack. The illustrated embodiment of the cart 100 defines a lift distance of up to two inches; however, further embodiments of the present invention may provide for any amount of vertical travel of the support surface. Once the rack 202 is substantially supported by the cart 100, the operator rotates the control handle 168 to drive the cart and rack backward, as shown in FIGS. 12A and 12B. As illustrated in FIG. 12A, the cart 100 is able to transition from the bed of the truck 200 to the ramp 206 while maintaining at least two sets of wheels on the bed and/or ramp, thus precluding the cart from bottoming out and obviating the need for the operator to exert any substantial amount of force on the cart. The ramp 206 of FIGS. 11A-12B is illustrated as being angled at 11 degrees relative to the truck bed and ground; however, the illustrated cart 100 may be similarly used with ramps at alternative angles relative to the ground and/or truck, and further embodiments of the present invention are specifically configured to perform similarly on ramps at alternative angles.

The cart 100 also ensures a safe descent of the cart and rack 202 by slowing the cart as it comes down the ramp. The combined weight of the cart 100 and rack 202 is significant and could overwhelm an operator but for the motorized drive wheel assembly 114 which slows the descent of the cart to approximately the drive speed governed by the control handles 168. This ability to control the descent of the cart 100 and rack 202 eliminates the need for special ramp features that slow descending carts and racks, such as rubber surfaces of varying thickness or the like.

As the cart 100 approaches the bottom of the ramp 206, the rear cart wheels 102 will contact the ground while the front cart wheels will momentarily remain on the ramp, as shown in FIG. 12B. During this period the drive wheels 154 and 156 will be positioned above the depression defined by the ground and bottom of the ramp. Because the motorized drive wheel assembly 114 is able to pivot about pins 158 and includes the weight 160, the drive wheels 154 and 156 will maintain contact with the ramp and/or ground as the cart passes over the depression. The weight 160 also provides a sufficient amount of weight, such as 65 pounds for the illustrated embodiment, so that the drive wheels 154 and 156 will maintain a sufficient amount of normal force so that the drive wheels will not lose traction. Therefore, the operator will not have to provide any substantial force to help the cart over the depression. Further embodiments of the cart have alternative configurations to ensure that the drive wheels maintain contact and continue to drive the cart as the cart passes over depressions of alternative shapes and other alternative contours.

The cart 100 and rack 202 are loaded back into the truck 200 in a reverse sequence as the cart and rack were unloaded. Once the cart 100 and rack 202 are fully inside the truck 200, the support surface 106 is lowered and then the cart is removed from beneath the rack in a reverse but similar sequence as it was originally positioned. The racks 202 include removable portions that allow emptied racks to be stacked and moved out of the way so that the cart 100 can access racks that are located further within the truck 200. Therefore, the cart 100 is able to conveniently transport all of the racks within a delivery truck 200. Further embodiments of the cart of the present invention may be used in alternative applications while providing for convenient material handling over similarly difficult conditions.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A cart for transporting materials, the cart comprising:
a cart frame defining an upper portion and a lower portion opposed thereto;
a support surface joined to the cart frame, wherein the support surface is capable of selective vertical movement relative to the upper portion of the cart frame;
a lift mechanism connected to the cart frame and to the support surface, wherein the lift mechanism is capable of selectively raising and lowering the support surface relative to the cart frame;
at least one wheel attached to the cart frame and extending from the lower portion of the cart frame;
a drive wheel assembly attached to the cart frame and capable of selectively providing drive motion to the cart in at least one direction;
and a control assembly capable of selectively raising and lowering the support surface and of selectively providing drive motion to the cart;
wherein the drive wheel assembly is capable of moving in at least a vertical direction relative to the cart frame while the drive wheel assembly provides drive motion to the cart in at least one direction.

2. A cart according to claim 1 wherein the drive wheel assembly is attached to the cart frame with a pivoting connection.

3. A cart according to claim 2 wherein the drive wheel assembly includes at least one drive wheel and at least one weight cantilevered opposite the at least one drive wheel from the pivoting connection.

4. A cart according to claim 3 wherein the drive wheel assembly includes at least one spring connected to the cart frame and proximate the at least one weight.

5. A cart according to claim 1 wherein the drive wheel assembly includes at least one drive wheel and includes a motor in selective rotational communication with the at least one drive wheel to selectively provide drive motion to the cart.

6. A cart according to claim 5 wherein the drive wheel assembly includes a gearbox comprising a transmission switch that enables selective engagement and disengagement of the motor and the at least one drive wheel.

7. A cart according to claim 5 wherein the motor defines a selectively variable speed and wherein the control assembly includes a handle shaft that is selectively rotatable to selectively control a speed of the motor.

8. A cart according to claim 1 wherein the drive wheel assembly includes two drive wheels and includes a differential in rotational communication with the two drive wheels, wherein the differential enables the two drive wheels to rotate at different relative speeds.

9. A cart according to claim 1 wherein the cart frame includes a lift mechanism having a motor that drives an actuator to selectively raise and lower the support surface.

10. A cart according to claim 9 wherein the lift mechanism further includes at least one shaft that is selectively rotated by the actuator, wherein the at least one shaft includes at least one cam follower that, when rotated, exerts a force on the support surface to selectively raise and lower the support surface.

11. A cart according to claim 1 wherein the cart frame includes at least one bushing defining an inner diameter and the support surface includes at least one pin defining an outer diameter, wherein the at least one pin is positioned generally coaxially within the at least one bushing.

12. A cart according to claim 1 wherein the cart frame defines a nose portion at an end of the cart opposite the control assembly and wherein the nose portion defines an angled top surface that tapers vertically downward as the cart frame extends in a direction away from the control assembly.

13. A cart according to claim 12 wherein the nose portion of the cart frame defines radiused corners.

14. A cart and rack assembly in which the rack selectively includes materials to be transported, the cart and rack assembly comprising:
a cart for transporting materials, the cart comprising:
a cart frame defining an upper portion and a lower portion opposed thereto;
a support surface joined to the cart frame, wherein the support surface is capable of selective vertical movement relative to the upper portion of the cart frame;
a lift mechanism connected to the cart frame and to the support surface, wherein the lift mechanism is capable of selectively raising and lowering the support surface relative to the cart frame and wherein the cart defines a raised position when the support surface is raised a maximum vertical distance from the cart frame and the cart defines a lowered position when the support surface is lowered to a minimum vertical distance from the cart frame;
at least one wheel attached to the cart frame and extending from the lower portion of the cart frame, wherein the at least one wheel defines a distal end opposite the cart frame in a generally vertical direction;
a drive wheel assembly attached to the cart frame and capable of selectively providing drive motion to the cart in at least one direction; and
a control assembly capable of selectively raising and lowering the support surface and of selectively providing drive motion to the cart;
wherein the drive wheel assembly is capable of moving in at least a vertical direction relative to the cart frame while the drive wheel assembly provides drive motion to the cart in at least one direction;
wherein the cart selectively defines a raised position dimension measured from the top of the support surface to the distal end of the at least one wheel when the support surface defines the raised position and the cart selectively defines a lowered position dimension measured from the top of the support surface to the distal end of the at least one wheel when the support surface defines the lowered position; and
a rack defining a bottom surface and including at least one foot extending from the bottom surface of the rack, wherein the foot defines a distal end opposite the bottom surface of the rack;
wherein the rack defines a clearance height between the bottom surface of the rack and the distal end of the at least one foot of the rack that is generally greater than the lowered position dimension of the cart and that is generally less than the raised position dimension of the cart.

15. A cart and rack assembly according to claim 14 wherein the drive wheel assembly is attached to the cart frame with a pivoting connection.

16. A cart and rack assembly according to claim 15 wherein the drive wheel assembly includes at least one drive wheel and at least one weight cantilevered opposite the at least one drive wheel from the pivoting connection.

17. A cart and rack assembly according to claim 16 wherein the drive wheel assembly includes at least one spring connected to the cart frame and proximate the at least one weight.

18. A cart and rack assembly according to claim 14 wherein the drive wheel assembly includes at least one drive wheel and includes a motor in selective rotational communication with the at least one drive wheel to selectively provide drive motion to the cart.

19. A cart and rack assembly according to claim 14 wherein the drive wheel assembly includes two drive wheels and includes a differential in rotational communication with the two drive wheels, wherein the differential enables the two drive wheels to rotate at different relative speeds.

20. A method of transporting material with a cart, the method comprising the steps of:
moving the cart having at least one wheel to a first position wherein at least a portion of a cart frame is situated generally below the material to be transported, wherein the cart includes a support surface joined to the cart frame;
raising the support surface of the cart with a lift mechanism until the materials are substantially supported by the support surface of the cart;
moving the cart to a second position by controlling a drive wheel assembly attached to the cart frame, wherein the drive wheel assembly is capable of moving in at least a vertical direction relative to the cart frame while the drive wheel assembly provides drive motion to the cart; and
lowering the support surface of the cart until the materials are substantially removed from the support surface of the cart.

21. A method according to claim 20 wherein moving the cart to a second position comprises moving the cart along a ramp and a ground surface such that an at least one wheel of the drive wheel assembly maintains substantially constant contact with the ramp or the ground surface immediately below the at least one wheel of the drive wheel assembly.

22. A method according to claim 21 wherein moving the cart to a second position comprises moving the material from a first position inside a vehicle to a second position proximate the ground surface.

23. A method according to claim 20 wherein raising the support surface comprises controlling a motor that drives an actuator that rotates at least one shaft having at least one cam follower that exerts an upward force on the support surface.

24. A method according to claim 20 wherein moving the cart to a second position comprises moving the cart along a ramp and a vehicle surface such that at least one wheel of the cart is unsupported by the ramp or vehicle surface when the cart is proximate a break point defined by the ramp and vehicle surface.

25. A method according to claim 20 wherein moving the cart to a first position comprises moving the cart along a ramp and a vehicle surface such that a nose portion that defines an angled top surface at one end of the cart passes beneath the materials without lifting of an opposite end of the cart.
